(19) United States
(12) Patent Application Publication
(10) Pub. No.: US 2008/0060338 A1
(43) Pub. Date: Mar. 13, 2008

(54) Ergonomic free standing gardening tool

(76) Inventor: William Nai-Jen Chang, Brampton (CA)

Correspondence Address: DAVID W. WONG, 46 WILLOWBROOK ROAD, THORNHILL, ON, L3T 4W9, US

(21) Appl. No.: 11/518,628

(22) Filed: Sep. 11, 2006

(51) Int. Cl. A01D 7/00

(52) U.S. Cl. 56/400.14

(57) ABSTRACT

An ergonomically designed gardening tool such as a rake has an elongated handle slidably and removably mounted to the tool head. A spike or an auxiliary gardening implement is mounted at the lower end of the handle such that the spike may be operated to secure the rake at an upright free standing position on a lawn or solid ground surface. The handle is secured to tool head with a latch mechanism which is operative to secure or release the handle from the rake head selectively. The removed handle with the auxiliary implement mounted thereon may also be used for various gardening tasks.

### BACKGROUND OF THE INVENTION

1. Field of the Invention

This invention relates to gardening tools and particularly an ergonomically designed gardening tool such as a rake which can be affixed temporarily on the ground in an upright free standing position to facilitate convenient use.

2. Background Art

Gardening such as raking is a strenuous operation and it requires the user to twist and bend the back frequently; thus it can cause a large amount of strain and stress to the user's back. Moreover, in carry out the gardening operation, the user must from time to time place the tool down on the ground or aside to pick up or collect the worked material, and then must bend down again to pick up the tool from the ground to resume gardening. Such frequent back bending can often cause injury to the user's back. Some tools provide a bend handle so as to alleviate the amount of bending by the user during gardening. However, they have not eliminated the need by the user having to bend down frequently to pick up the tool from the ground.

U.S. Pat. No. 5,878,563 to P. L. Dutcher shows the incorporation of a rotatable stand attached to the head of the rake. The stand may be turned to a position at an angle to the head of the rake to support the rake to stand in an upright manner on the ground when it is not being used such that the user is not necessary to bend down to pick it up from the ground. However, the stand does not provide a satisfactory secure support of the rake on an uneven or sloping lawn surface or in a windy condition.

### SUMMARY OF THE INVENTION

It is a principal object of the present invention to provide an ergonomically designed gardening tool particularly a rake which can securely rest on the ground in an upright freestanding position.

It is another object of the present invention to provide a rake having a securing system incorporated thereon for securing it on uneven or sloping lawn surface.

It is another object of the present invention to provide an ergonomically designed rake having a securing system for affixing it firmly on a lawn in a windy condition.

It is another object of the present invention to provide an ergonomically designed garden tool having different parts therein removable for various gardening operations.

It is yet another object of the present invention to provide an ergonomically designed rake which is simple in structure, easy to operate and inexpensive to produce.

### BRIEF DESCRIPTION OF THE DRAWINGS

Other objects and advantages of the present invention will become apparent from the following detailed description of the preferred embodiments thereof in connection with the accompanying drawings, in which

FIG. 1 is a perspective front elevation view of the ergonomically designed rake according the present invention.

FIG. 2 is a perspective side elevation view thereof.

FIG. 3 is an isolated perspective side elevation view showing the securement of the rake to the ground to maintain it in an upright position.

FIG. 4 is an isolated enlarged elevation view of the releasable locking mechanism for the handle of the rake.

FIG. 5 is an isolated enlarged elevation view showing the release of the locking mechanism to allow the ground spike provided at the lower end of the handle to be extended to affix the rake on the lawn temporarily.

FIG. 6 is an isolated enlarged top elevation view of an alternative locking mechanism of the handle.

FIG. 7 is a front perspective elevation view of the rake of the present invention with a V-shaped tip formed in the spike.

FIG. 8 is an exploded front perspective elevation view showing the removable of the handle from the rake head of the rake for other purposes such as weed removable.

FIG. 9 is a side perspective elevation view showing the placement of the rake on a solid ground surface.

FIG. 10 is a perspective elevation view showing the rake having an auxiliary smaller rake mounted on the handle which is removable for various gardening purposes.

### DETAILED DESCRIPTION OF THE PREFERRED EMBODIMENTS

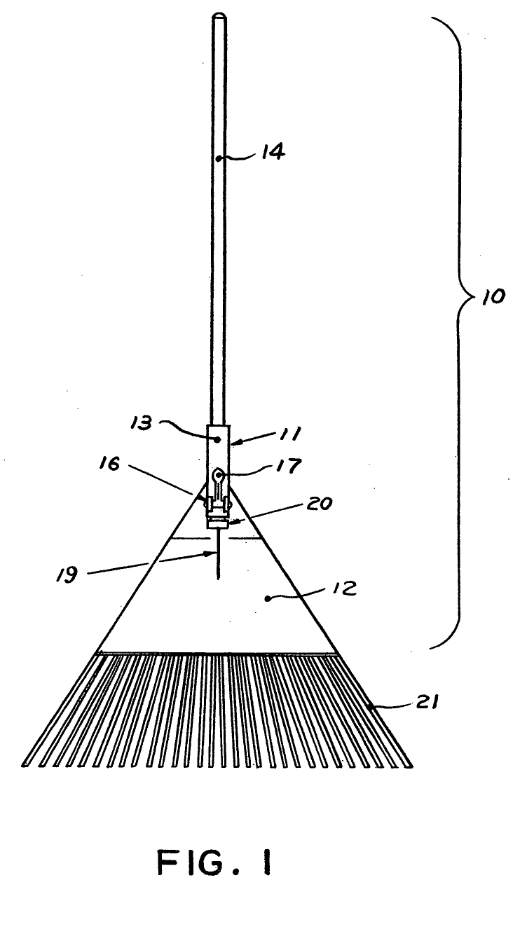

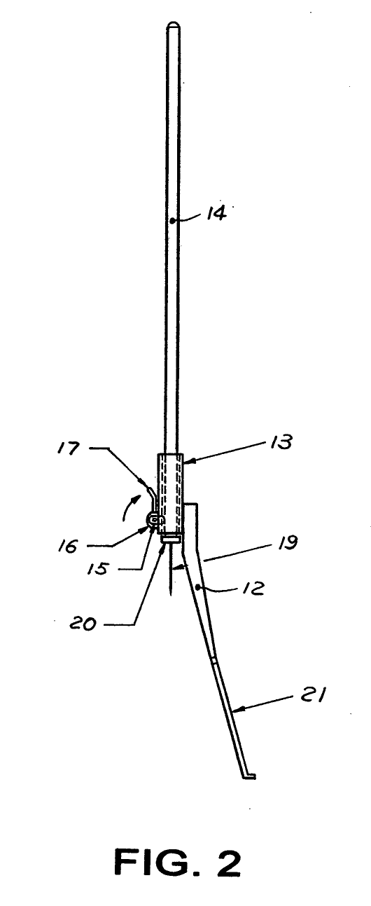

With reference to the drawings in which like reference numerals in the several views designate corresponding parts, the rake 10 according to the present invention has a latch mechanism 11 provided at the center of the front top position of its head 12. A rake is shown as an example for illustrating the present invention, it can be understood that the construction is applicable to a variety of garden tools. The latch mechanism 11 may consist of a sleeve 13 through which the elongated handle 14 of the rake slidably extends therethrough. The rake head 12 may ergonomically and preferably extend at a small angle about 10 to 25 degrees relative to the vertical longitudinal axis of the sleeve 13. The angle enhances the raking action such that the user may carry out the raking operation in an almost upright position without the usual back bending as in using a common rake. A cam member 15 is rotatably mounted on a bracket 16 located on the side wall of the sleeve 13. The bracket 16 preferably is U-shaped as best shown in FIG. 1 to provide a strong support for the latch mechanism. The cam member 15 is rotatable by a latch handle 17 mounted to the cam member 15. The latch handle 17 may be turned to a vertical position to cause a cam portion 18 of the cam member 15 to urge tightly against the handle 14 so as to retain it securely in position without any sliding movement, or alternatively it may be turned to a downwards away from the vertical position to release the engagement of the cam portion 18 from the surface of the handle 14 such that the latter may be slidably moved up or down through the sleeve 13 relative to the head 12. A spike 19 is mounted at the lower end of the handle 14. An abutment ring 20 is mounted on the handle 17 and located adjacent to its lower end. The abutment ring 20 has an outside diameter larger than the inside diameter of the sleeve 13 so that it serves as an abutment to prevent the handle 14 from sliding upwards outside of the sleeve 13. The spike 19 is located above the raking fingers 21 when the handle 14 is located at such highest position.

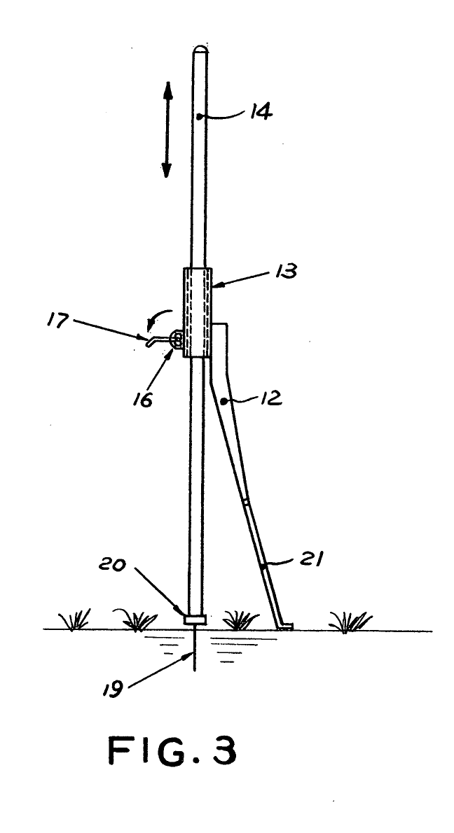

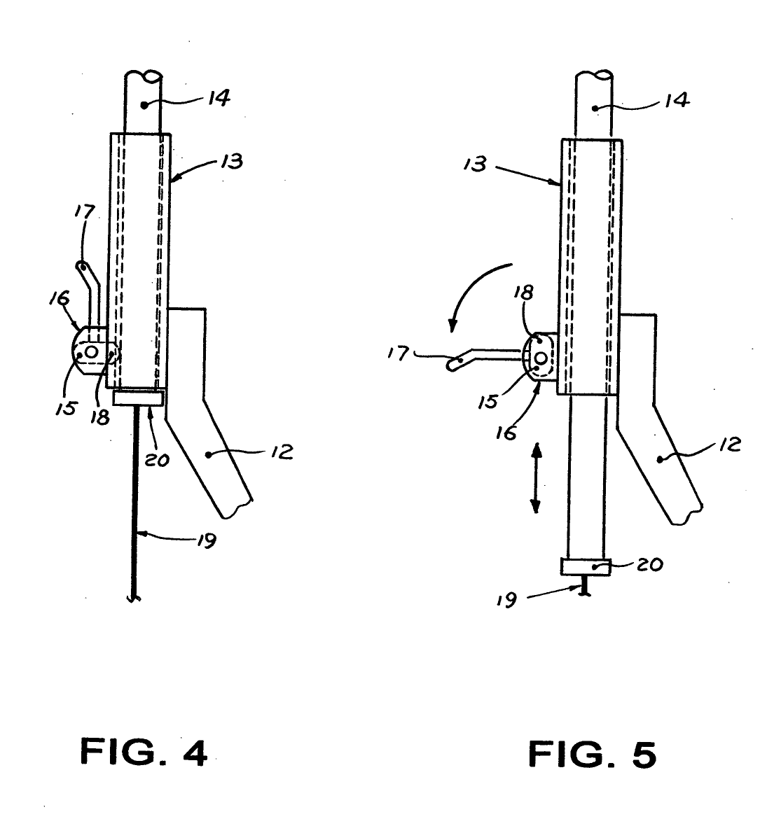

For performing the raking operation, the latch handle 17 is operated to lock the rake head 12 at a selected position on the handle 14, normally this would be the lowest position with the abutment ring 20 juxtaposed to the lower end of the sleeve 13 so that the user has the longest handle for the raking operation. Other positions may also be selected conveniently to suit the height of the user. When not performing the raking operation, the user would operate the latch handle 17 to release the securement of the handle 14 to the rake head 12, and the handle 14 would be lowered until the spike 19 passes below the lower edge of the raking fingers 21 and the latch handle 17 is operated to lock the handle 14 at such selected lower position. With the handle 17 locked at such position, the rake 10 may be secured to the lawn or a soil surface by merely pushing the spike 19 into the ground as best shown in FIG. 3. The spike 19 provides a firm securement of the rake 10 on the ground in an upright manner regardless of whether the ground surface is uneven or sloping or in a windy condition. Furthermore, the rake head 12 in cooperation with the handle 14 which is already secured into the ground, would also serve as an additional support of the rake 10 at the upright position.

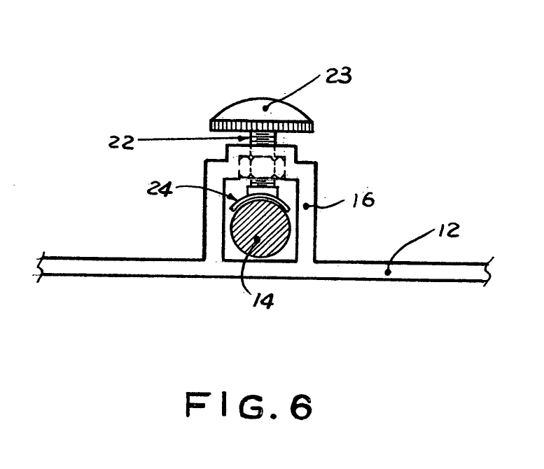

An alternative embodiment of the latch mechanism is shown in FIG. 6, which consists of a threaded bolt 22 threadingly mounted on the bracket 16. A handle such as a round knob 23 is provided on the bolt 22 and it is operative for urging the end of the bolt 22 against the handle 14 to secure it in place within the sleeve 13, and it may be operated to release the securement of the handle 14 to the rake head 12. An arcuate plate 24 may be mounted at the end of the bolt 22 to provide enhance engagement of the latch mechanism with the handle 14.

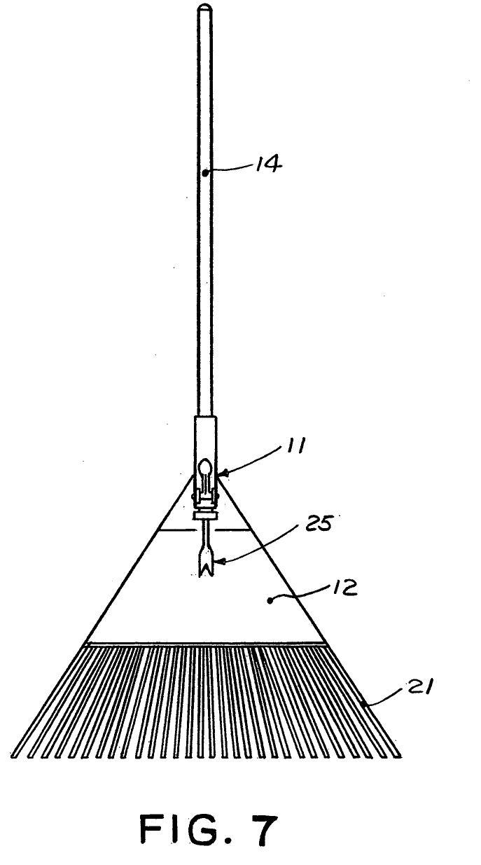

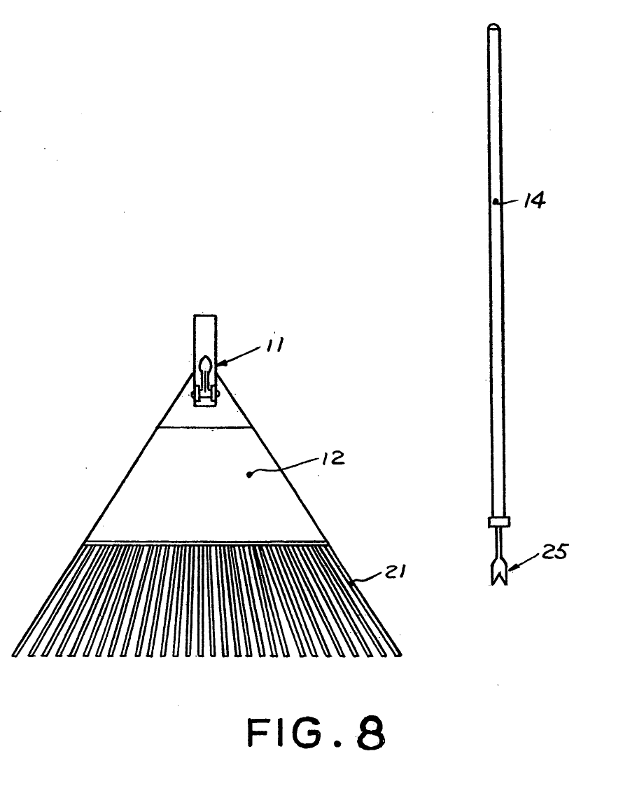

The elongated handle 14 with the spike 19 provided at its lower end may also be removed from the rake head 12 and be used for other purposes such as weed removable, loosening of the soil, making aeration openings in the lawn, and picking up debris and garbage from the ground. A V-shaped tip 25 is formed in the spike 19 to facilitate its use as a weed remover as shown in FIGS. 7 and 8.

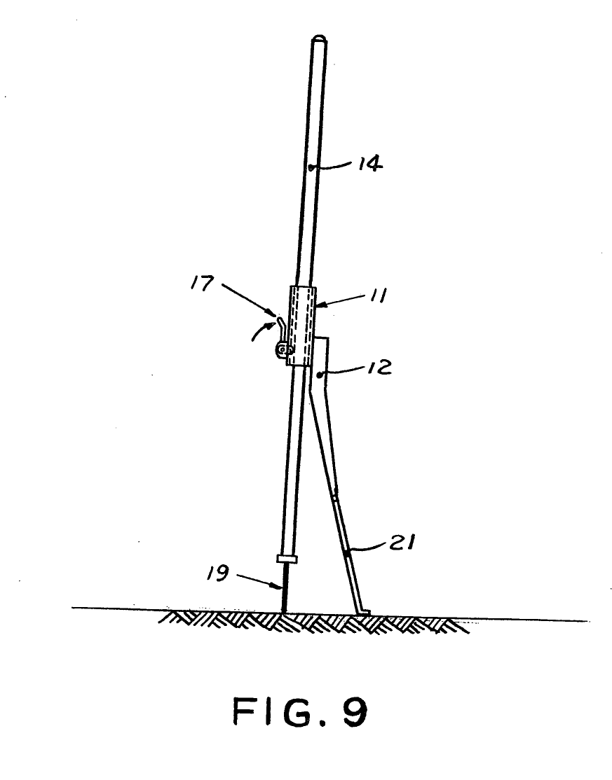

The rake 10 may also be free standing on a solid ground surface as shown in FIG. 9 with the spike and the lower edge of the raking fingers serving as the necessary support stand.

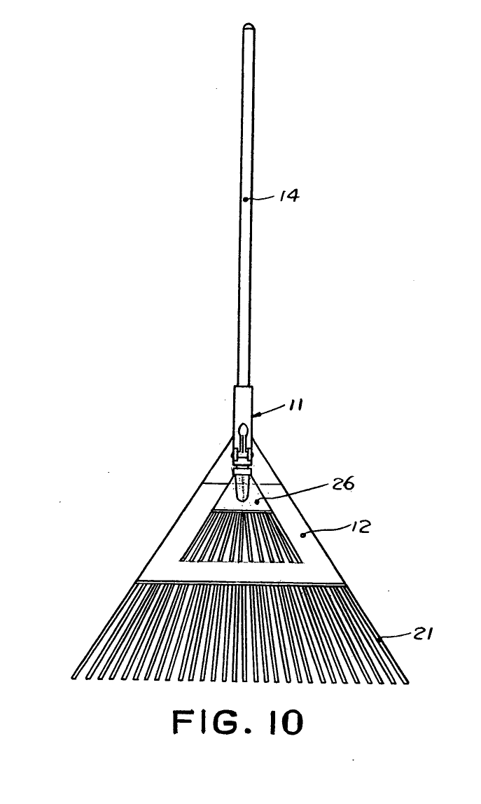

An auxiliary small rake 26 may alternatively mounted on the bottom end of the handle 14 as shown in FIG. 10. The handle may be removed from the rake head 12 for using the small rake 26 for various gardening tasks such as cleaning the ground around small areas in a flower bed or loosening the soil in small areas. The small rake 26 may also cooperate with the main rake 12 for resting the rake 10 on the ground in a free standing upright position.

The ergonomically designed garden tool particularly the rake of the present invention, despite of its simple construction, it can be secured to ground firmly and be maintained at a free standing upright position for convenient fetching for use for any ground profile or weather condition. It is also simple to use and inexpensive to manufacture.

While the present invention has been shown and described in the preferred embodiments thereof, it will be apparent that various modifications can be made therein without departing from the spirit or essential attributes thereof, and it is desired therefore that only such limitations be placed thereon as are imposed by the appended claim.

1. An ergonomic gardening tool comprising:
a rake head mounted on a sleeve, said rake head having a plurality of eongated raking fingers,
an elongated handle slidably extending through said sleeve,
a latch mechanism provided on said sleeve, said latch mechanism having a securement operative to secure said rake head at a selected position on said handle, and also operative selectively to for facilitating sliding movement of said sleeve relative to said handle to position said rake head at said selected position on said handle with said raking fingers extending downwardly at an angle of between 10 to 25 degrees relative to the vertical axis of said handle,
said latch mechanism including a cam plate rotably mounted on a fixed bracket located at a side wall portion of said sleeve, said cam plate having a turnable handle pivotable relative to said bracket for causing an arcuate cam surface portion of said cam plate to extend sideway from said sleeve to press against said elongated handle for securing said rake head at said selected position.
a spike mounted at a bottom end of said handle, said latch mechanism being operative for securing said rake head at a lower position on said handle with lower free ends of said raking fingers cooperative with said spike for supporting said tool securely in a free standing upright manner on a ground.

2-5. (canceled)

6. An ergonomic tool according to claim 1 including a ring mounted at a bottom end portion of said handle, said ring having an outside diameter larger than the inside diameter of said sleeve to serve as an abutment for locating said rake head at a lowest position on said handle with said raking fingers extending below said spike.

7. An ergonomic gardening tool according to claim 6 wherein said spike has a V-shaped tip.

8-10. (canceled)

11. An ergonomic gardening tool comprising:
a main rake head mounted on a sleeve, said main rake head having a plurality of elongated raking fingers.
an elongated handle slidably extending through said sleeve,
a latch mechanism provided on a front portion of said sleeve, said latch mechanism having a securement operative to secure said main rake head at a selected position on said handle, with said raking fingers extending downwardly at an angle of between 10 to 25 degrees relative to the vertical axis of said handle, and said latch mechanism being operative selectively to release said securement for facilitating sliding movement of said main rake head relative to said handle and selectively to remove said main rake head from said handle, said latch mechanism including a cam plate rotably mounted on a fixed bracket located at a front side wall portion of said sleeve, said cam plate having a turnable handle pivotable relative to said bracket for rotating an arcuate cam surface portion of said cam plate to extend sideway inwardly from said sleeve to press tightly against said elongated handle for securing said main rake head at said selected position,
an auxiliary gardening implement also fixedly mounted at said bottom end of said handle, said handle with said auxiliary gardening implement mounted thereon being operative for conducting various gardening tasks with said main rake head removed from said handle.

12. An ergonomic gardening tool according to claim 11 wherein said auxiliary gardening implement is an auxiliary rake head having a size smaller than said main rake head.

13. An ergonomic gardening tool according to claim 11 wherein said auxiliary gardening implement is a spike having a V-shaped tip.
